(19) United States
(12) Patent Application Publication
(10) Pub. No.: US 2003/0055827 A1
(43) Pub. Date: Mar. 20, 2003

(54) Apparatus and method for performing background web searches

(75) Inventors: Susann Marie Keohane, Austin, TX (US); Johnny Meng-Han Shieh, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 09/956,770

(22) Filed: Sep. 20, 2001

(51) Int. Cl. G06F 7/00

(52) U.S. Cl. 707/10

(57) ABSTRACT

An apparatus and method that allow a user to perform a secondary passive web search while performing a first web search are provided. The first web search is performed in the foreground while the second web search is performed in the background. In one embodiment of the invention, keywords or phrases for which to search are provided. Each time a web document is displayed, the document is parsed for the occurrence of the keywords or phrases. In another embodiment, the search is performed on the Internet at large in conjunction to performing the test on displayed web documents. In either case, links for documents which contain the keywords or phrases are stored in a bookmarks folder.

### BACKGROUND OF THE INVENTION

1. Technical Field

The present invention is directed to a search engine. More specifically, the present invention is directed to an apparatus and method capable of performing background searches.

2. Description of Related Art

As is well known by now, the World Wide Web (WWW) or Internet is a system of servers that support specially formatted documents. The documents are formatted in a script called Hyper Text Markup Language (HTML) that supports links to other documents as well as graphics, audio and video files. This allows a user to jump from one document or web page to another by just clicking on the links embedded in a displayed web page.

Due to the number of servers that make up the Internet, a great amount of information is readily available to a user. However, to take full advantage of this benefit, the user has to be able to wade through this amount of information fairly easily. To facilitate this task, various search engines are made available trough the Internet. A search engine is a program that searches documents for specified keywords or phrases and returns a list of the documents where the keywords or phrases are found. Some search engines are independent standalone search engines such as google.com. Others are available through web portals such as yahoo.com.

In any case, when using a search engine, the user types in a keyword or a phrase that will most likely return documents about a subject matter. A list of web pages where the keyword or phrase is found is then returned. The user then has to access each returned page to determine its relevance. As alluded to above, each document may contain at least one link to another document, and therefore, it is very conceivable that the user, while inspecting a returned web page for its relevance, may jump from one page to another using the links embedded in each successively displayed document before accessing another web page from the original list.

Nonetheless, as the user is inspecting each page for its relevance, it may occur to the user to search for another subject matter or subject matters. Presently, when a user wants to search for a second subject matter while in the process of searching for a first subject matter, the user has to either make a note, mental or otherwise, to search for the second subject matter or abandon the first search to start the second search.

If the user chooses to make a note, the user has to remember to actually perform the search. If the user abandons the first search to perform the second search, the user may never finish the first test.

What is needed, therefore, is an apparatus and method that will allow a user to search for the second subject matter while still searching for the first subject matter.

### SUMMARY OF THE INVENTION

The present invention provides an apparatus and method that allow a user to perform a second web search in the midst of evaluating a first web search. The progression through the first web search is performed in the foreground while the second web search is performed in the background. In one embodiment of the invention, keywords or phrases for which to perform the secondary background search are provided. Each time a web document is displayed, the document is parsed for the occurrence of the keywords or phrases for the second background search.

In another embodiment, the secondary search is automatically conducted in the background upon each link returned from the search engine as a result of the search words provided for the primary search. In either case, links for documents which contain the keywords or phrases are stored in a bookmarks folder.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a flow diagram of the invention.

### DETAILED DESCRIPTION OF THE PREFERRED EMBODIMENT

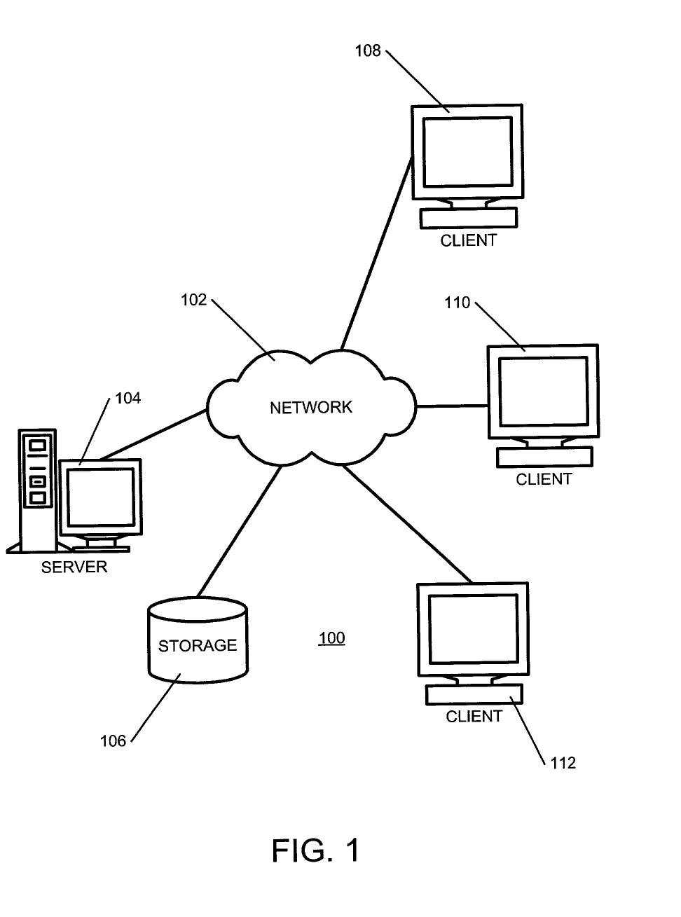

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

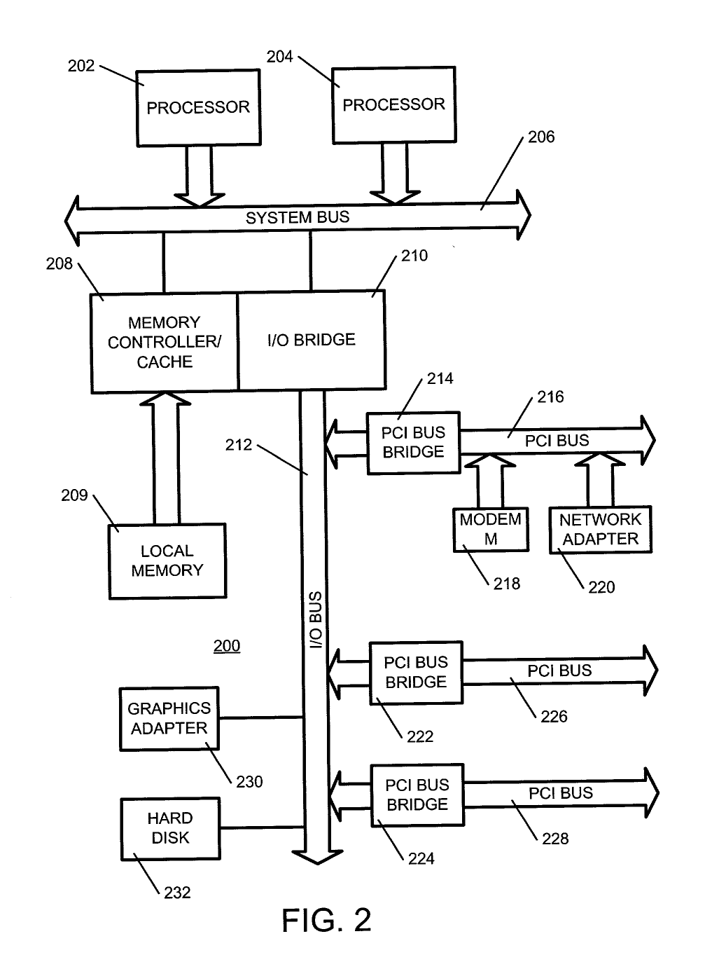

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, New York, running the Advanced Interactive Executive (AIX) operating system or LINUX operating system.

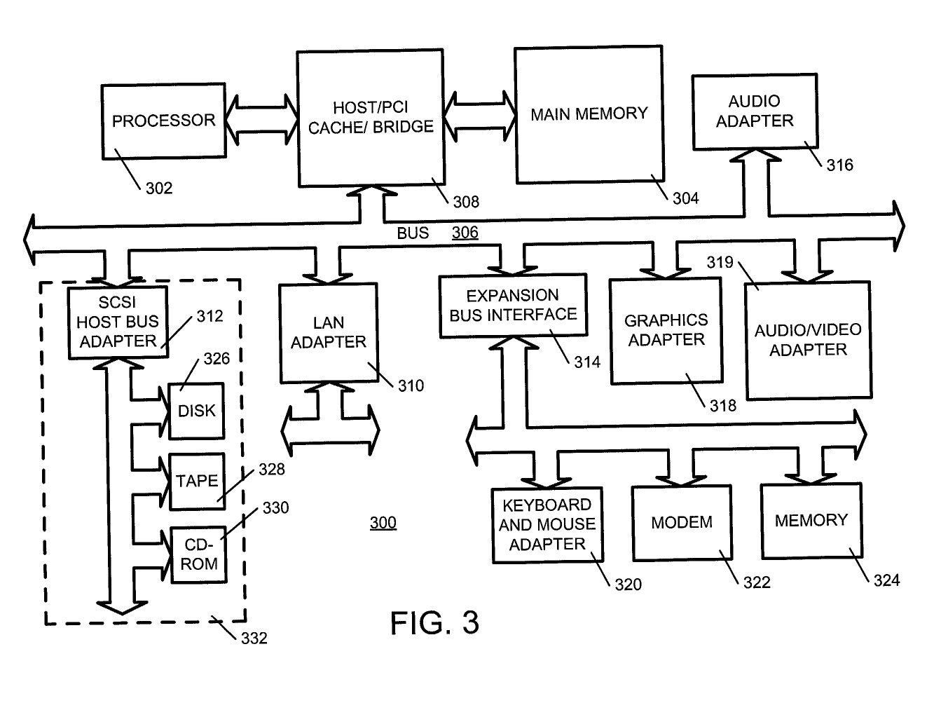

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method that allow a user to perform concurrent searches for two subject matters over the Internet, one in the foreground and one in the background. The invention is, in essence, a search engine that may be embedded in an Internet browser or pluggable into the browser. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

To better understand the invention, an example will be provided. Suppose a user wants to buy a DVD player. If prudent, the user will want to review articles about DVD players before actually buying one. Suppose further, the user likes Sony products. The user may tailor the search to retrieve web pages or articles about Sony DVD players. While reviewing these articles, suppose the user reads a comment that compares a particular Sony DVD player with a particular JVC DVD player. The user may then want to search articles regarding JVC DVD players also. As stated above, presently when confronted with a choice of continuing a first search or starting a second search, a user has to choose to either make a note to perform the second search at a later time or abandon the first search to start the second search. Using the present invention, however, the user may search for articles regarding JVC DVD players while continuing accessing articles regarding the Sony DVD players.

To do so, the user needs to access the invention, possibly through a pull-down menu, and enter the keywords or phrases needed for the invention to search for articles regarding the JVC DVD players. Depending on its configuration, the invention may do a new Internet search for articles regarding the JVC DVD players or may search each newly visited web page from that point forward. In either case, the search will be totally transparent to the user. The web pages returned may be stored into a set or folder of bookmarks. This folder may use the first keyword as title. In the alternative, the user may be prompted, when the invention is accessed, to provide a title for the folder.

Just as with existing search engines, the invention may arrange the bookmarked pages based on their relevance to the subject matter of the search, or based on keyword hits or based on the order they were generated.

When ready to do so the user may, through a pull-down menu option, access the bookmarked pages in the folder. Before exiting each accessed bookmarked page, the user may be prompted to store the bookmark in the Favorites folder (i.e., the folder containing the regular bookmarks), delete the folder or leave it where it is. Of course, the user may delete the entire folder at any time.

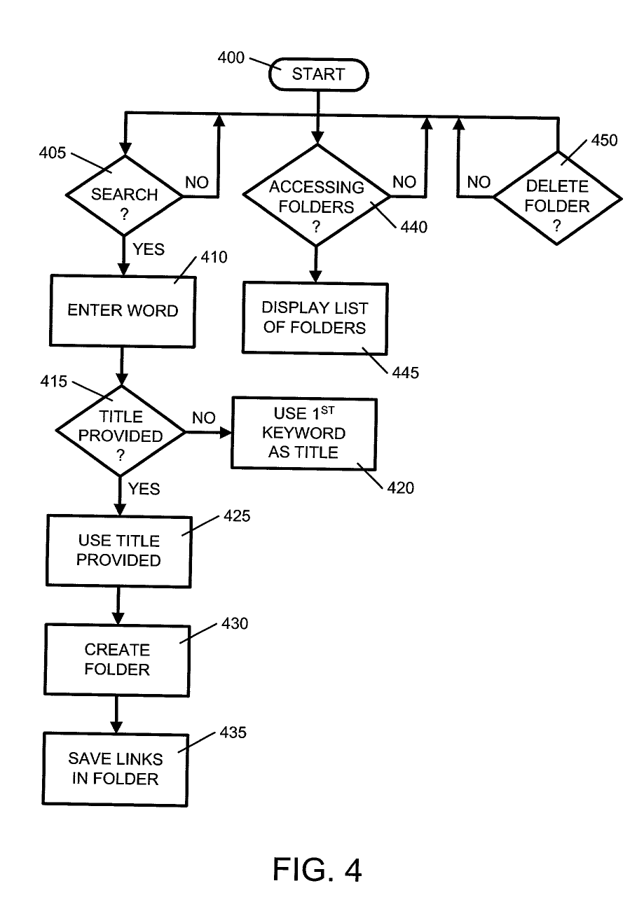

FIG. 4 is a flow diagram of the invention. To start the process, the user may have to click on an icon. The icon may be located near the search icon or the favorites icon of existing browsers and may be called “background search”. When the icon is clicked on, a menu is pulled down. The menu may contain three items. The items may be labeled “search”, “accessing folders”, “deleting folders”.

When the process starts (step 400), three checks are continuously being made. The checks are to determine whether “search”, “accessing folders” or “deleting folders” is clicked on from the menu. If “search” is clicked on, the user will be prompted to enter a keyword or phrase to search for (steps 405 and 410). When the user enters the keyword or phrase, the user will be prompted to enter a name for the folder in which the result of the search will be stored. If the user clicks on start search without providing a name, the keyword or phrase entered will be used as the name of the folder. The first word in the phrase or group of keywords may always be used as the default name for the folder (steps 415 and 420). If the user enters a name, the name will be used as the name of the folder. The folder will be created and links retrieved during the search will be saved therein (steps 415, 425, 430 and 435). Note that if the search did not retrieve any links, a note may be put in the folder to let the user know that that the search was performed but no links were found.

If the user clicks on “accessing folders” a list of folders from prior background searches will be displayed. At that point, the user needs only click on the folder of interest to see its content (steps 440 and 445). If the user clicks on “delete folder”, the list of folders from previous background searches will be displayed. The user may then delete any folder from the list using regular methods of deleting folders.

The description of the present invention has been presented for purposes of illustration and description, and is not intended to be exhaustive or limited to the invention in the form disclosed. Many modifications and variations will be apparent to those of ordinary skill in the art. For example, more than one background search may be performed with the invention. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of performing concurrent web searches using one browser comprising the steps of:
performing a first web search; and
performing at least one more web search, said at least one more web search being a background search.

2. The method of claim 1 wherein said at least one more web search is performed on displayed web documents.

3. The method of claim 2 wherein said displayed web documents are from links returned by said first web search.

4. The method of claim 3 wherein links returned by said at least one more web search are bookmarked.

5. The method of claim 4 wherein said bookmarked links from said at least one more web search are stored at a different location than general bookmarked links.

6. A computer program product in a computer readable medium for performing concurrent web searches using one browser comprising:
code means for performing a first web search; and
code means performing at least one more web search, said at least one more web search being a background search.

7. The computer program product method of claim 6 wherein said at least one more web search is performed on displayed web documents.

8. The computer program product of claim 7 wherein said displayed web documents are from links returned by said first web search.

9. The computer program product of claim 8 wherein links returned by said at least one more web search are bookmarked.

10. The computer program product of method of claim 9 wherein said bookmarked links from said at least one more web search are stored at a different location than general bookmarked links.

11. An apparatus for performing concurrent web searches using one browser comprising:
means for performing a first web search; and
means for performing at least one more web search, said at least one more web search being a background search.

12. The apparatus of claim 11 wherein said at least one more web search is performed on displayed web documents.

13. The apparatus of claim 12 wherein said displayed web documents are from links returned by said first web search.

14. The apparatus of claim 13 wherein links returned by said at least one more web search are bookmarked.

15. The apparatus of claim 14 wherein said bookmarked links from said at least one more web search are stored at a different location than general bookmarked links.
